(19) United States
(12) Patent Application Publication
(10) Pub. No.: US 2004/0056377 A1
(43) Pub. Date: Mar. 25, 2004

(54) Method for making a shoe sole

(76) Inventors: Wen-Sheng Hsu, Tainan (TW); Jui-Yun Tien, Nan Tour Hsien (TW)

Correspondence Address: Cooper & Dunham LLP, 1185 Avenue of the Americas, New York, NY, 10036, US

(21) Appl. No.: 10/252,809

(22) Filed: Sep. 23, 2002

(51) Int. Cl. B29C 44/04

(52) U.S. Cl. 264/45.4

(57) ABSTRACT

A method for making a sole includes the steps of material preparing, placing material in a mold, vacuuming the mold, foaming the material inside the mold and opening the mold to present the product. A raw material for making the sole and a colored material are prepared and the raw material is sliced and cut into sole-shaped pieces. Then the sole-shaped pieces and the colored material are placed in a mold. After the bottom mold and the top mold are combined in an air-tight manner, air is completely drawn out of a chamber. When heat is supplied to allow the sole-shaped pieces to combine with the colored material, opening the mold will present a sole with clear separation between the color of the sole body and the area where the colored material is located.

### BACKGROUND OF THE INVENTION

1. Field of the Invention

The present invention relates to a method for making a shoe sole, and more particularly to a method that is able to form a colorful sole in a single process.

2. Description of Related Art

A conventional sole generally is made of a single material so that the color of the sole is monotonous and is pretty dull. To overcome the drawback, an improved method is introduced to the market, which employs colored materials to increase the attraction of the sole. However, when this kind of method is in process, normally there are more than two different processes involved to combine the sole with the colored materials via heat during the foaming process of the material to make the sole, which is quite complex and lengthy. Furthermore, during the foaming process of the sole material, because air is mixed in the foaming process, voids with large dimensions are formed in the sole, which degrades the quality of the sole.

To overcome the shortcomings, the present invention tends to provide an improved method for making a sole with different colors in a single process to mitigate and obviate the aforementioned problems.

SUMMARY OF THE INVENTION

The primary objective of the present invention is to provide an improved method for making a sole with different colors in a single process so as to save cost and energy.

In order to accomplish the foregoing objective, the method of the present invention includes material preparing, placing material in a mold, vacuuming the mold, foaming the material inside the mold and opening the mold.

Further, the device for making the sole comprises a bottom mold and a top mold each having a sole-shaped recess to form a chamber when the bottom mold and the top mold are combined. The bottom mold has a closed area formed by an integrally formed baffle on top of a bottom face defining the recess to receive therein a colored material such that when the foaming material for making the shoe sole is placed inside the chamber and heated, whereafter the colored material combines with the shoe sole material.

Other objects, advantages and novel features of the invention will become more apparent from the following detailed description when taken in conjunction with the accompanying drawings.

### BRIEF DESCRIPTION OF THE DRAWINGS

FIG. 1 is a flow chart showing the steps of the present invention;

FIG. 2 is an exploded perspective view of the bottom mold and the sole material

FIG. 3 is a plan view showing that the sole material is placed in the mold;

FIG. 4 is a schematic plan view showing that the bottom mold moves upward to engage with the top mold so as to form a chamber;

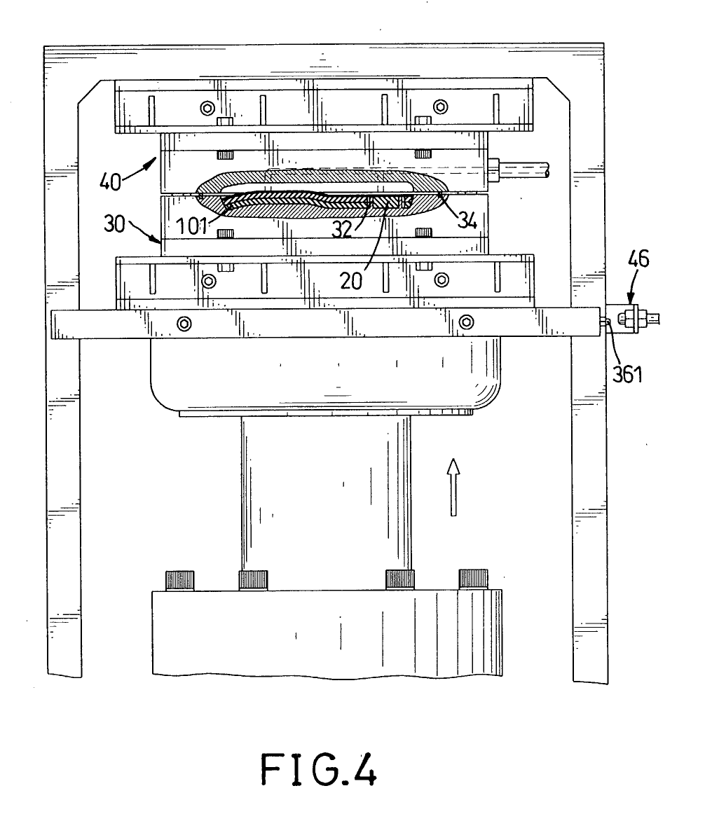

FIG. 5 is a schematic plan view showing that the bottom mold keeps moving upward to deform the seal so that the chamber is able to be ready for vacuum processing;

FIG. 6 is a schematic view showing that the sole material as well as the colored material has undergone the foaming process;

FIG. 7 is a schematic view of the bottom mold being moved away from the top mold to show the product of the present invention;

FIG. 8 is a top view of the sole with a color inside the sole;

FIG. 9 is a schematic view showing the device of another embodiment of the present invention; and

FIG. 10 is a top plan view showing the sole made by the device shown in FIG. 9.

### DETAILED DESCRIPTION OF THE PREFERRED EMBODIMENT

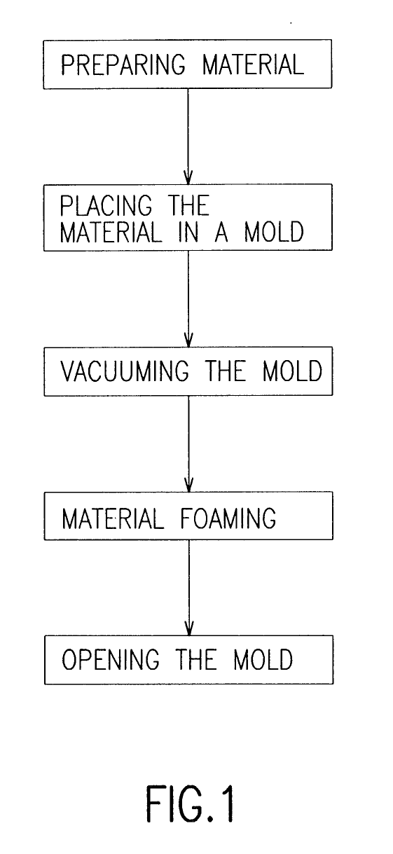

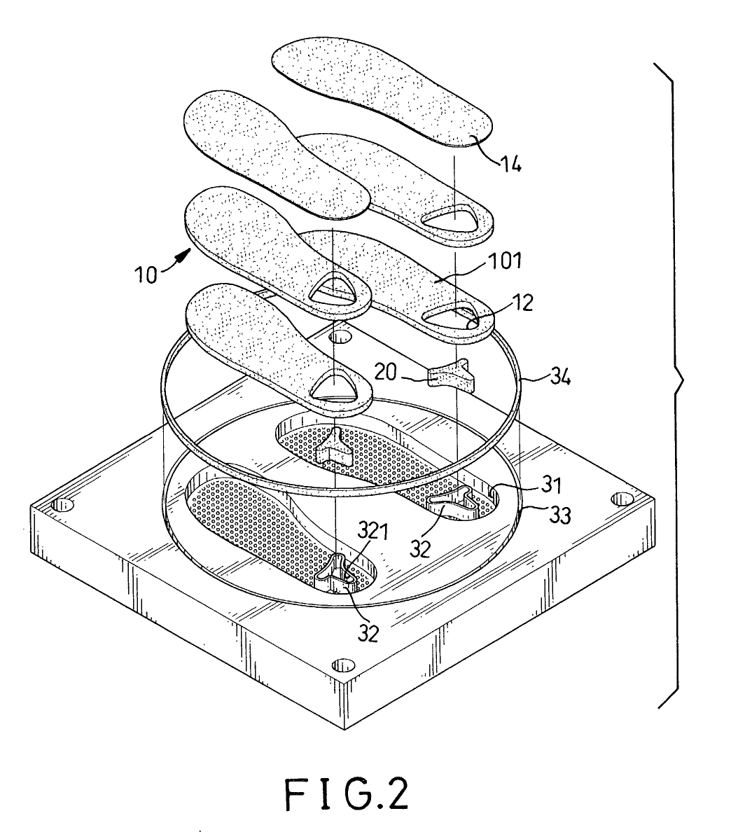

With reference to FIGS. 1 and 2, the method in accordance with the present invention includes the steps of material preparing, placing material in a mold, vacuuming the mold, foaming the material inside the mold and opening the mold to present the product.

In the material preparing step, a raw material (10) for making the sole and a colored material (20), preferably ethylene vinyl acetate copolymer (EVA) and being able to foam when heated are prepared. The raw material (10) is sliced and cut into sole-shaped pieces (101). The colored material (20) made of the same material as that of the sole-shaped pieces (101) but having a color different to that of the sole-shaped pieces (101) is also prepared. Each sole-shaped piece (101) has a hole (12) defined to correspond to the colored material (20) and having a dimension larger than that of the colored material (20).

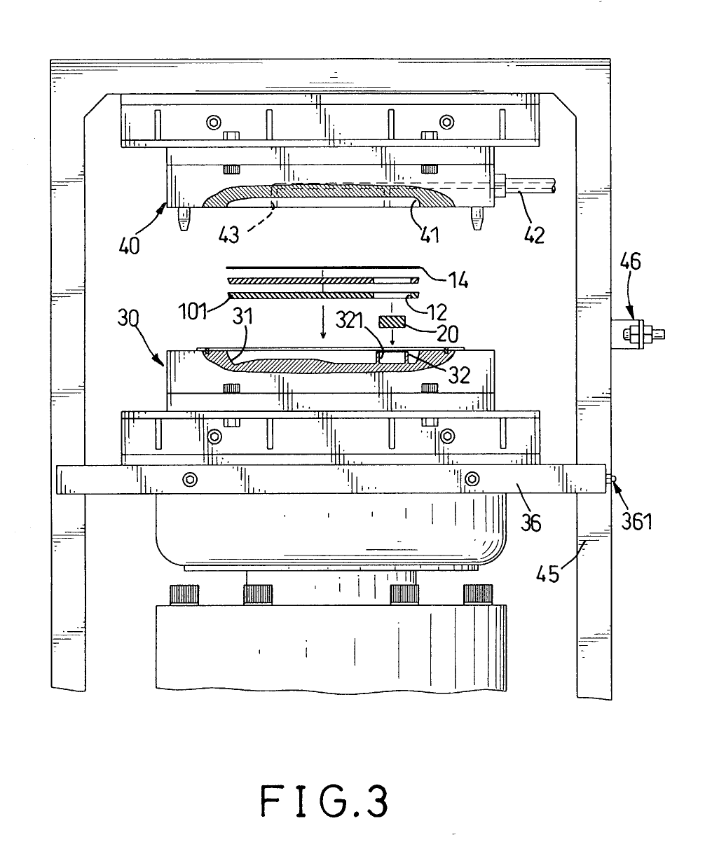

With reference to FIGS. 2 and 3, the mold includes a bottom mold (30) with a sole-shaped first recess (31) and a top mold (40) with a sole-shaped second recess (41) corresponding to the first recess (31). An integrally formed baffle (32) is formed on a bottom face defining the first recess (31) so that a room (321) is defined in the baffle (32) to receive therein the colored material (20). An annular recess (33) is defined around the first recess (31) to receive therein a seal (34) and the annular recess (33) is so defined that when the seal (34) is received in the annular recess (33), a top edge of the seal (34) protrudes out from a top face of the bottom mold (30). The hole (12) also has a dimension larger than that of the room (321) so that when the colored material (20) is received in the room (321), multiple sole shaped pieces (101) are stacked on top of the first recess (31) and a top sole piece (14) without the hole (12) is placed on top of the stacked sole-shaped pieces (101) to enclose the colored material (20) in the holes (12) of the sole-shaped pieces (101). It is noted that the sole-shaped pieces (101) and the top sole piece (14) may be formed into one piece, that is, a top sole piece with a third recess defined to correspond to the holes (12) of the sole-shaped pieces (101) is employed on top of the stacked sole-shaped pieces (101) so as to sandwich the colored material (20) with the bottom mold (30).

The bottom mold (30) further has a positioning rod (361) located on a side of a base (36) which is securely provided on a bottom of the bottom mold (30) and is movable relative to a bracket (45). The top mold (40) is securely mounted on a bottom face of the bracket (45) and has a sensing switch (46), i.e. a micro-switch, a tube (42) connected to a pump (not shown) and having an outlet (43) extending through and out of the top mold (40) to face the bottom mold (30).

In the mold vacuuming process, after the sole-shaped pieces (101), the colored material (20) and the top sole piece (14) are placed in the first recess (31), the bottom mold (30) is moved toward the top mold (40) until the positioning rod (361) blocks the micro-switch (46). When the positioning rod (361) blocks the micro-switch (46), the micro-switch (46) stops the movement of the bottom mold (30) at a point where the seal (34) engages with a bottom face of the top mold (40). Meantime, the micro-switch (46) initiates the pump to suck the air out of the chamber composed of the first recess (31) and the second recess (41).

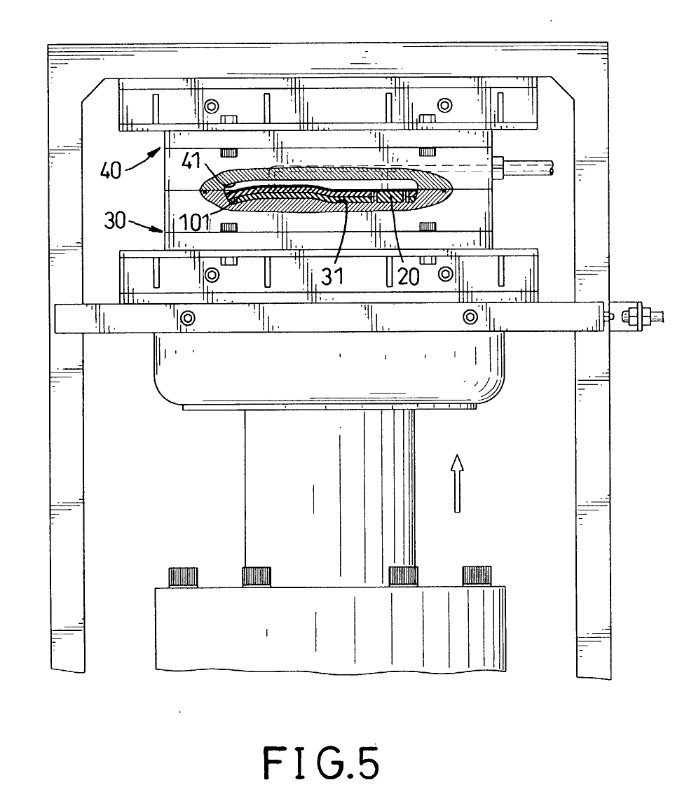

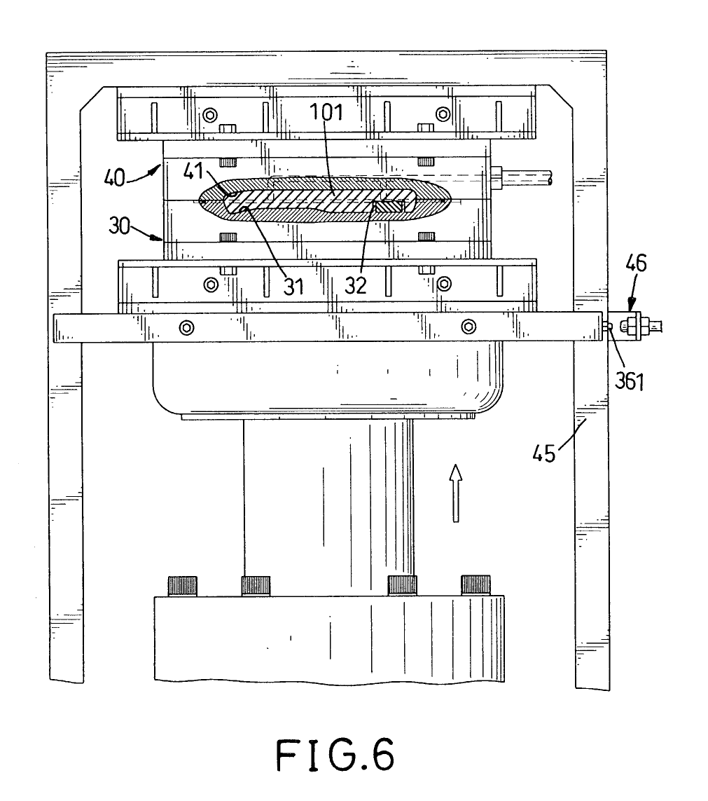

In the material foaming process, with reference to FIGS. 5 and 6, after the air is completely sucked out of the chamber, the micro-switch (46) sends a signal to continue to move the bottom mold (30) toward the top mold (40) to deform the seal (33). Heat is supplied to activate the foaming process of the sole-shaped pieces (101) as well as the colored material (20), wherein the temperature is around 150 to 200 degrees Centigrade degrees for around 6 to 15 minutes. Because the sole-shaped pieces (101), the top sole piece (14) and the colored material (20) are made of the same material, during the foaming process, the sole-shaped pieces (101), the top sole piece (14) as well as the colored material (20) are combined together into one piece. Further, because all the air inside the chamber has been evacuated out of the chamber, the dimension of the voids possibly created during the foaming process is small, which results in a good durable product.

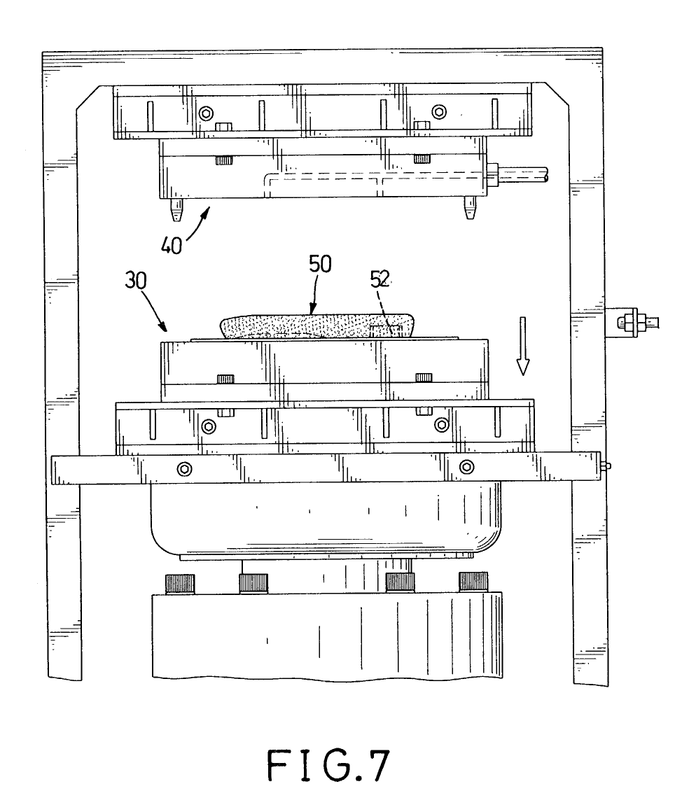

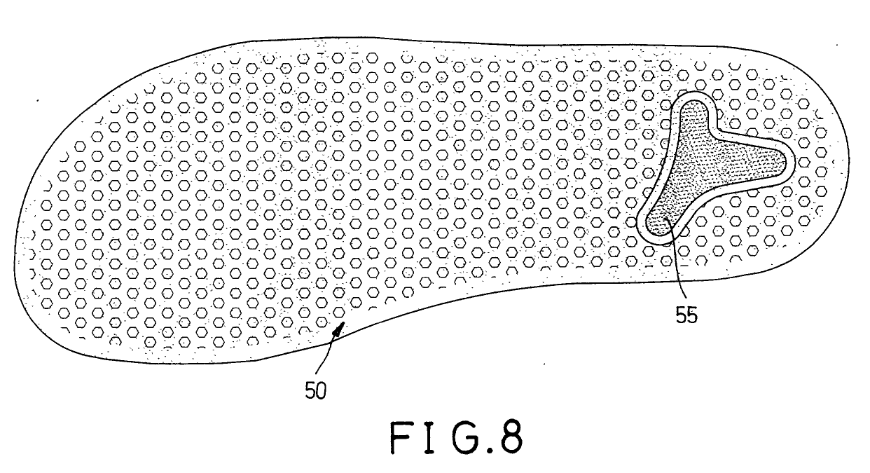

After the foaming process is finished, the bottom mold (30) is moved downward to expose the product to finish the steps of the method, wherein the finished sole (50) with the colored material (52) having undergone the foaming process has a colored area (55), as is shown in FIGS. 7 and 8.

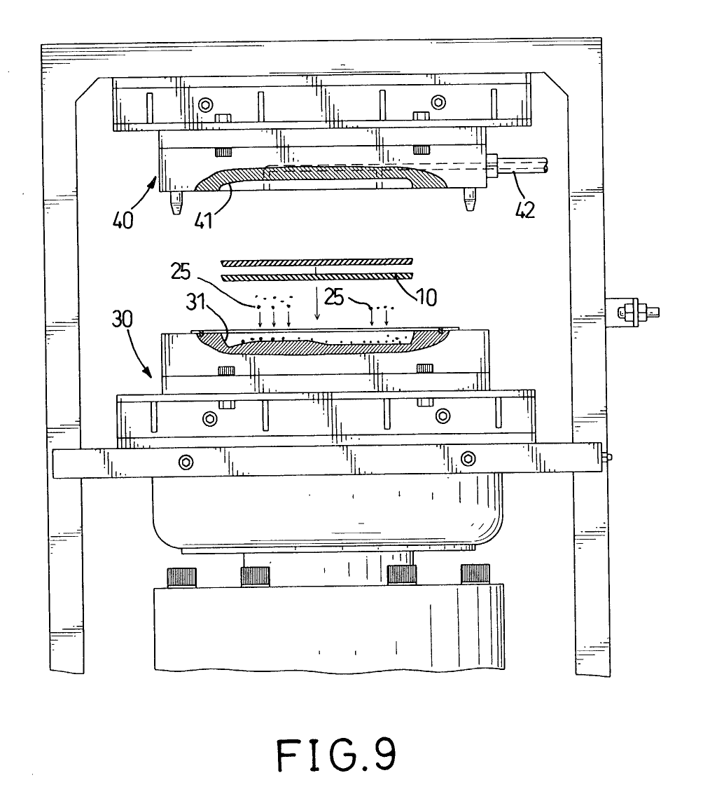

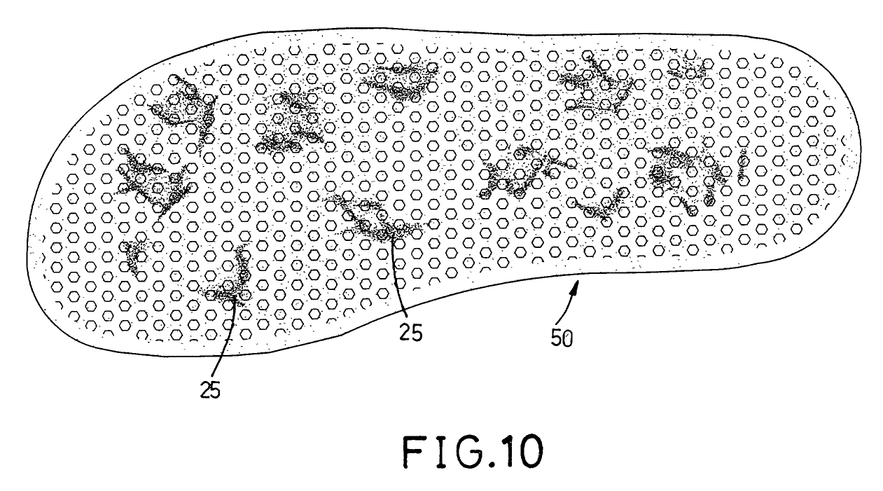

With reference to FIGS. 9 and 10, another embodiment of the present invention is presented to omit the baffle (32). Instead, color powder (25) is dispersed on the bottom surface defining the first recess (31). Then, steps of vacuuming the mold, foaming the material inside the mold and opening the mold are sequentially completed. Thereafter, because of the pressure and temperature during the foregoing steps, the color powder is mixed into the sole-shaped pieces (101) and then presented in the sole (50). Again, the color powder (25) may be employed to the room (321) defined in FIG. 2 so that the sole (50) may have the feature as presented in FIGS. 8 and 10.

In conclusion, the method of the present invention has the following advantages:

1. Because of the baffle and the room, during the foaming process, the color from the colored material is not mixed with the sole-shaped piece. A clear separation between the color of the sole-shaped pieces (101) and the colored material (20) is formed.

2. Because of the seal, the vacuuming process is able to draw all the air away to the outside the chamber. During the foaming process, the dimension of the voids in the sole (50) is maintained to a minimum.

3. Using colored powders in the sole presents diversities of the color changes so that the appearance of the sole is increased. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making a sole comprising the steps of:
material preparing, wherein a raw material for making the sole and a colored material having a color different to a color of the raw material are prepared;
placing raw material and the colored material in a mold, wherein the raw material is sliced and cut into sole-shaped pieces each having therein a hole to receive therein the colored material, and then the sole-shaped pieces and the colored material are placed in a mold composed of a bottom mold with a sole-shaped first recess and a top mold with a sole-shaped second recess corresponding to the first recess;
vacuuming the mold, wherein after the bottom mold and the top mold are combined in an air-tight manner, air is completely drawn out of a chamber defined by the first recess and the second recess;
foaming the material inside the mold, wherein because all the air inside the chamber is drawn out, when heat is applied to the material the sole shaped pieces and the colored material undergo a chemical reaction so as to combine the sole-shaped pieces and the colored material; and
opening the mold to present a product.

2. The method as claimed in claim 1, wherein temperature in the foaming step is around 150 to 200 degrees Centigrade.

3. The method as claimed in claim 2, wherein a time period for heat supplying is around 6 to 15 minutes.

4. A method for making a sole comprising the steps of:
material preparing, wherein a raw material for making the sole and a colored material are prepared;
placing material in a mold, wherein the raw material is sliced and cut into sole-shaped pieces and then the sole-shaped pieces and the colored material are placed in a mold composed of a bottom mold with a sole-shaped first recess and a top mold with a sole-shaped second recess corresponding to the first recess;
vacuuming the mold, wherein after the bottom mold and the top mold are combined in an air tight manner, air is completely drawn out of a chamber defined by the first recess and the second recess;
foaming the material inside the mold, wherein because all the air inside the chamber is drawn out, when heat is applied to the material the sole shaped pieces and the colored material undergo a chemical reaction so as to combine the sole-shaped pieces and the colored material; and
opening the mold to present a product.

5. The method as claimed in claim 4, wherein temperature in the foaming step is around 150 to 200 degrees Centigrade.

6. The method as claimed in claim 5, wherein a time period for heat supplying is around 6 to 15 minutes.

7. The method as claimed in claim 6, wherein the colored material is colored powder.
